(19) United States
(12) Patent Application Publication
(10) Pub. No.: US 2009/0096870 A1
(43) Pub. Date: Apr. 16, 2009

(54) GPS with back up camera

(76) Inventor: Edward Zheng, La Verne, CA (US)

Correspondence Address: DAVID AND RAYMOND PATENT FIRM, 108 N. YNEZ AVE., SUITE 128, MONTEREY PARK, CA, 91754, US

(21) Appl. No.: 12/287,667

(22) Filed: Oct. 9, 2008

Related U.S. Application Data
(60) Provisional application No. 60/998,521, filed on Oct. 10, 2007.

(51) Int. Cl. H04N 7/18

(52) U.S. Cl. 348/148; 348/E07.085

(57) ABSTRACT

A wireless GPS camera system for a vehicle includes a GPS unit, a back up surveillance unit, a display unit and a control unit. The display unit is electrically connected with the GPS unit and the back up surveillance unit for selectively displaying the positioning information and the video information. The control unit is electrically connected with the GPS unit and the back up surveillance unit to operate the wireless GPS camera system between a GPS mode and a back up monitoring mode, wherein in the GPS mode, the GPS unit is activated to allow the positioning information to be displayed on the display unit, wherein in the back up monitoring mode, the back up surveillance unit is activated to allow the video information to be displayed on the display unit.

### CROSS REFERENCE OF RELATED APPLICATION

This is a non-provisional application of a provisional application having an application No. 60/998,521 and a filing data of Oct. 10, 2007.

### BACKGROUND OF THE PRESENT INVENTION

1. Field of Invention

The present invention relates to a GPS and more particularly to a GPS coupled with a back up camera for automatically switching between a GPS mode and a back up mode.

2. Description of Related Arts

Global Positioning Systems (GPS) have widely been utilized around the world for precisely and promptly guiding a vehicle's driver as to his or her position. A typical GPS can also be pre-programmed to provide a real-time guidance as to the driving direction between a starting point and one or more other destination. As a matter of conventional arts, GPS is usually built-in into the dash board of a vehicle the driver is capable of utilizing a GPS whenever he or she is driving.

On the other hand, a vehicle back up camera system has also widely been utilized around the world for providing a real-time image to a rear side of a vehicle so that a driver is able to observe any obstacle or pedestrian behind his or her vehicle. A typical vehicle back up camera system usually comprises a camera mounted on a rear side of the vehicle, and a monitoring unit mounted within the cabinet of the vehicle and is electrically connected with the camera for displaying an image captured by that camera in a real-time basis. Very often, this kind of vehicle back up camera system will also be built-in into the vehicle so that the driver is able to utilize it whenever he or she is driving.

There exist some disadvantages for the above mentioned conventional devices. First and foremost, as briefly mentioned earlier, the GPS and the vehicle back up camera system are mainly built-in in a brand new vehicle so that they are readily for use when the purchases a vehicle. As a result, their electrical and mechanical components are incorporated into other mechanical and electrical components of the vehicle and are not customary to disassemble. In other words, when the user needs to drive another car or purchase another new car which does not have the GPS and/or the vehicle back up camera system, the user is not able to enjoy the convenience and the utility of the GPS and the vehicle back up camera system anymore.

Moreover, some vehicles are only equipped with either GPS or the vehicle back up camera system. So when the user wishes to utilize both GPS and the vehicle back up camera system, the user must purchase the one which is not built-in in the vehicle. As a result, the user has to go through what may be a complicated process of installing a GPS or a vehicle back up camera system into his or her vehicle.

A problem associated with this phenomenon is that when an additional GPS or the vehicle back up camera system is manually installed in the vehicle, some of the components are overlapped. For example, when a built-in GPS is installed in the vehicle, and the user has to manually install another vehicle back up camera system in the same vehicle, two displaying devices, such as two monitors, may eventually be installed into the vehicle. This can be considered as components redundancy. Furthermore, when two separate driving assistance systems (i.e. the GPS and the vehicle back up camera system) are installed into the vehicle, the driver has to operate the two systems separately and this will definitely bring great hassle to that driver. Thus, the two separate driving assistance systems require different power outlets of the vehicle. However, if the vehicle only provides one single power outlet, the driver must unplug one of the driving assistance systems and then plug the desired driving assistance system to the power outlet for operation. In addition, even though the vehicle provides two power outlets, the vehicle battery must be powerful enough to support the driving assistance systems at the same time when the driving assistance systems are plugged to the power outlets.

### SUMMARY OF THE PRESENT INVENTION

A main object of the present invention is to provide a GPS camera system which is adapted for automatically switching between a GPS mode and a back up mode so as to provide an optimal driving assistance to a driver.

Another object of the present invention is to provide a GPS camera system which comprises a single control panel and a single display device for automatically displaying the positioning information and the rear image of the vehicle. In other words, the required physical components for GPS and vehicle back up camera system can be minimized.

Another object of the present invention is to provide a GPS camera system which is easy to installed into a vehicle and disassemble from that vehicle, so that a user is able to convenient use the GPS camera system of the present invention in different vehicles without going through complicated installation and disassembling procedures.

Another object of the present invention is to provide a GPS camera system which can be used in virtually all kinds of vehicles. As a result, the present invention is suitable for widespread application.

Accordingly, in order to accomplish the above objects, the present invention provides a wireless GPS camera system for a vehicle, comprising:

a GPS unit which comprises a GPS processing module adapted for detachably mounting into the vehicle, wherein the GPS processing module is arranged to provide a real-time positioning information of the vehicle;

a back up surveillance unit which comprises a surveillance camera adapted for detachably mounting on a rear side of the vehicle, wherein the surveillance camera is arranged to provide video information at the rear side of the vehicle;

a display unit electrically and wirelessly connected with the GPS unit and the back up surveillance unit for selectively displaying the positioning information and the video information; and

a control unit electrically connected with the GPS unit and the back up surveillance unit to operate the wireless GPS camera system between a GPS mode and a back up monitoring mode, wherein in the GPS mode, the GPS unit is activated to allow the positioning information to be displayed on the display unit, wherein in the back up monitoring mode, the back up surveillance unit is activated to allow the video information to be displayed on the display unit.

These and other objectives, features, and advantages of the present invention will become apparent from the following detailed description, the accompanying drawings, and the appended claims.

### BRIEF DESCRIPTION OF THE DRAWINGS

FIG. 1 is a front view of the wireless GPS camera system according to a preferred embodiment of the present invention, illustrating that the GPS unit is functioning.

FIG. 2 is a rear view of the wireless GPS camera system according to the above preferred embodiment of the present invention.

FIG. 3 is a front view of the wireless GPS camera system according to a preferred embodiment of the present invention, illustrating that the back up surveillance unit is functioning.

FIG. 4 is a schematic diagram of the wireless GPS camera system according to the above preferred embodiment of the present invention.

FIG. 5 is a side view detachable camera mount of the wireless GPS camera system according to the above preferred embodiment of the present invention.

FIG. 6 is a front view detachable camera mount of the wireless GPS camera system according to the above preferred embodiment of the present invention.

FIG. 7 is a side view of the wireless GPS camera system according to the above preferred embodiment of the present invention.

FIG. 8 is a block diagram of the wireless GPS camera system according to the above preferred embodiment of the present invention.

FIG. 9 is a schematic view illustrating the wireless GPS camera system supported at the windshield of the vehicle.

### DETAILED DESCRIPTION OF THE PREFERRED EMBODIMENT

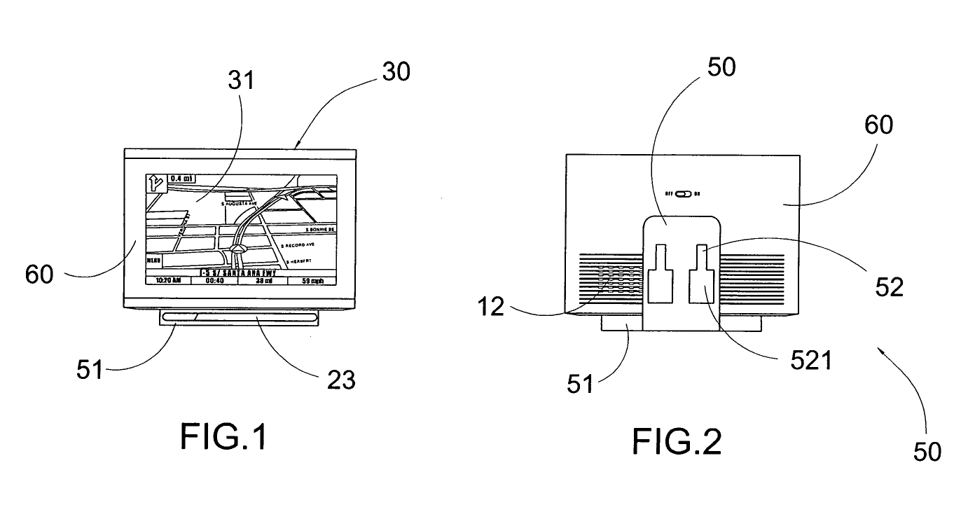

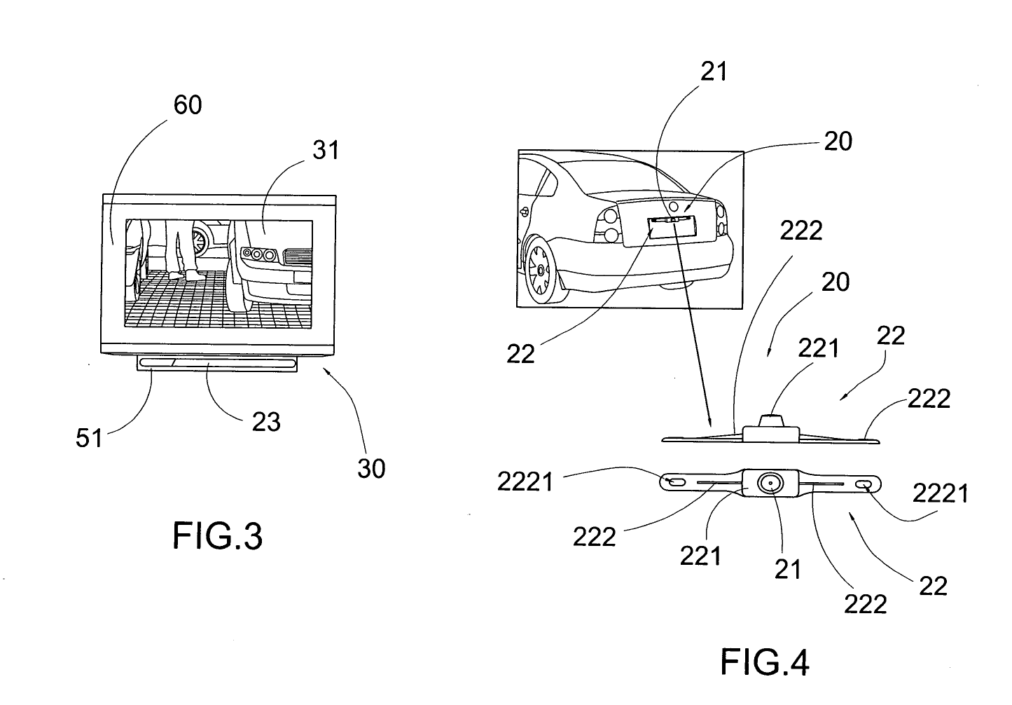

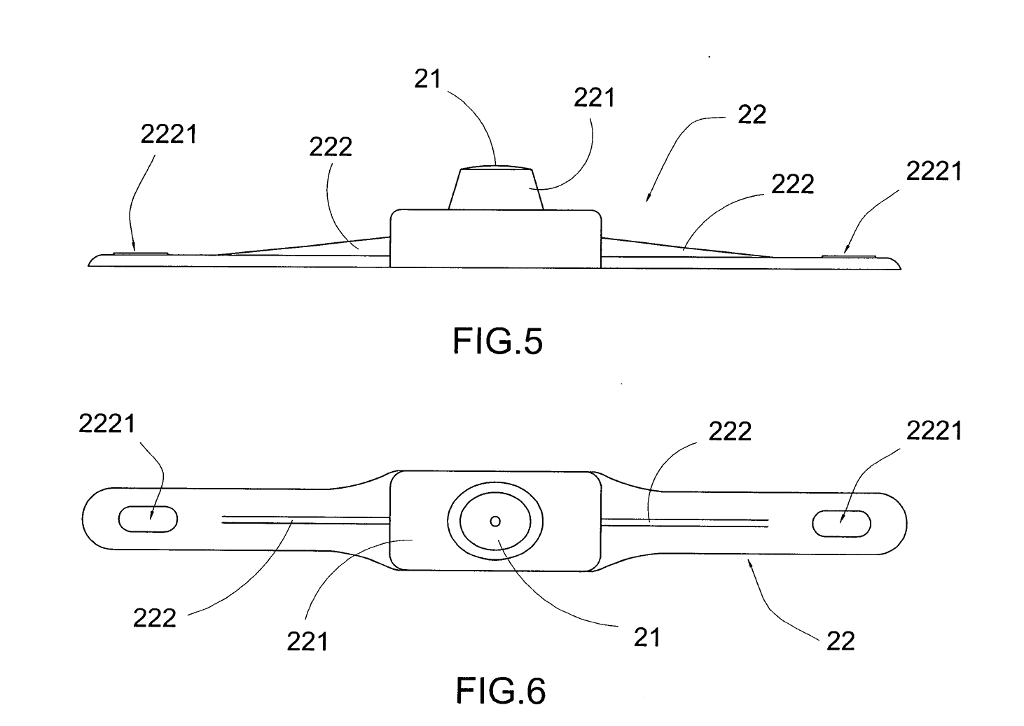

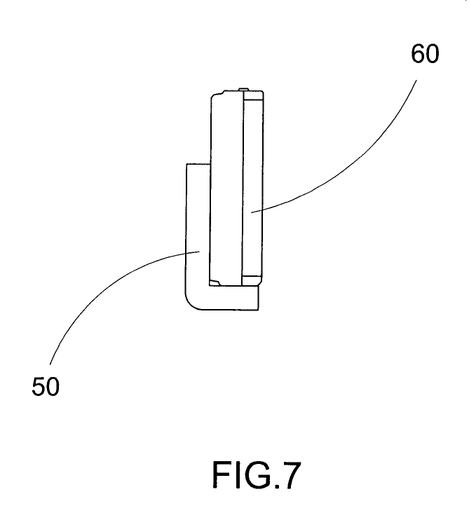

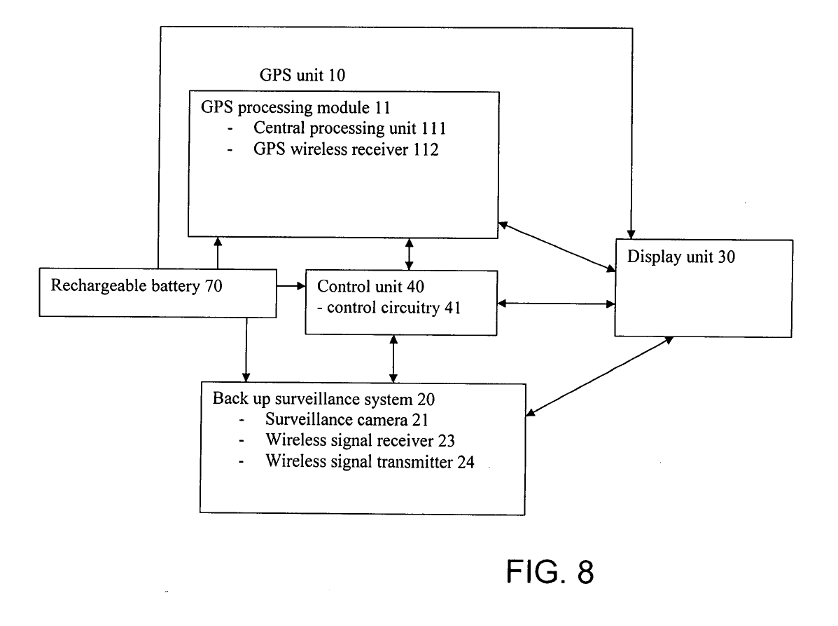

Referring to FIG. 1 to FIG. 8 of the drawings, a wireless GPS camera system for a vehicle according to a preferred embodiment of the present invention is illustrated, in which the wireless GPS camera system comprises a GPS unit 10, a back up surveillance unit 20, a display unit 30, and a control unit 40.

The GPS unit 10 comprises a GPS processing module 11 adapted for detachably mounting into the vehicle, wherein the GPS processing module 11 is arranged to provide a real-time positioning information of the vehicle.

The back up surveillance unit 20 which comprises a surveillance camera 21 adapted for detachably mounting on a rear side of the vehicle, wherein the surveillance camera 21 is arranged to provide video information at the rear side of the vehicle.

The display unit 30 is electrically and wirelessly connected with the GPS unit 10 and the back up surveillance unit 20 for selectively displaying the positioning information and the video information.

On the other hand, the control unit 40 is electrically connected with the GPS unit 10, the back up surveillance unit 20 and the display unit 30 to operate the wireless GPS camera system between a GPS mode and a back up monitoring mode, wherein in the GPS mode, the GPS unit 10 is activated to allow the positioning information to be displayed on the display unit 30, wherein in the back up monitoring mode, the back up surveillance unit 20 is activated to allow the video information to be displayed on the display unit 30.

According to the preferred embodiment of the present invention, the GPS processing module 11 of the GPS unit 10 comprises a central processing unit 111 and a GPS signal receiver 112 electrically connected with the central processing unit 111, wherein the GPS signal receiver 111 is adapted to receive a satellite signal from a predetermined satellite network. The satellite signal is then processed by the central processing unit 111 for generating the positioning signal of the GPS unit 10 which should be the positioning signal of the vehicle when the GPS unit 10 is mounted into that vehicle. The positioning signal of the GPS unit 10 is then displayed through the display unit 30. Preferably, the central processing unit 111 of the GPS unit 10 is pre-loaded with a predetermined national map and a predetermined operating system for interactively guiding the driver as to the driving direction of the vehicle.

The back up surveillance system 20 further comprises a detachable camera mount 22 detachably mounted onto the rear side of the vehicle wherein the surveillance camera 21 is detachably mounted onto the detachable camera mount 22 so that the surveillance camera 21 is capable of detachably mounting onto the rear side of the vehicle for capturing a rear image of the vehicle. More specifically, the detachable camera mount 22 is adapted for detachably mounting onto a rear license plate of the vehicle, and comprises a camera housing 221 having a receiving cavity for receiving the surveillance camera 21 therein, and two supporting arms 222, each having a connecting hole 2221 formed thereon, integrally and transversely extended from two sides of the camera housing 221 respectively, wherein the connecting holes 2221 are aligned with the connecting pins of the license plate of the vehicle so that the mounting between the detachable camera mount 22 and the vehicle will not induce any extra destructive holes or slots on the rear side of the vehicle, because the connecting pins of the vehicle are already there for connecting the license plate onto the vehicle.

On the other hand, the GPS camera system further comprises a utility housing 60 defining a utility cavity for securely receiving the display unit 30, the control unit 40 and the GPS unit 10 therewithin to form a portable GPS device such that the user is able to carry the utility housing 60 to find the positioning information.

Accordingly, the display unit 30 comprises a touch screen 31 of a predetermined size which is received in the utility cavity for selectively displaying the positioning information and the video information of the vehicle at a front side of the utility housing 60. Preferably, a diagonal length of the touch screen 31 should be approximately 4.3 inches for optimally displaying the positioning information or the video information of the vehicle.

In order to mount the GPS unit 10, the display unit 30, the control unit 40 into the vehicle, the GPS camera system further comprises a detachable docking 50 detachably mounted into the vehicle, wherein the GPS unit 10, the display unit 30 and the control unit 40 are securely mounted within the utility housing 60 which is then detachably mounted on the detachable docking 50. As it is mentioned above, when the utility housing 60 is detached from the detachable docking 50, the utility housing 60, receiving the display unit 30, the control unit 40 and the GPS unit 10 therein, forms the portable GPS device.

Preferably, the GPS unit 10 further comprises a speaker unit 12 provided in the utility housing 60 and electrically connected with the GPS processing module 11 for generating an audible sound to guide the driver as to the positioning information of the vehicle. For example, when a particular driving direction is sought, the speaker unit 12 is adapted to deliver an audible signal for guiding the driving as to the particular driving direction in light of the positioning information of that vehicle (e.g. a right turn instruction in a particular intersection).

In order to allow optimal interaction between the display unit 30 and the back up surveillance unit 20, the back up surveillance unit 20 further comprises a wireless signal receiver 23 mounted in the detachable docking 50 and electrically connected with the control unit 40 and the display unit 30, wherein the wireless signal receiver 23 is wirelessly connected with the surveillance camera 21 for receiving a wireless signal corresponding to an image captured thereby. Accordingly, the back up surveillance unit 20 further comprises a wireless signal transmitter 24 provided in the surveillance camera 21 for transmitting a wireless signal corresponding to the image captured thereby. The wireless signal is then received by the wireless signal receiver 23. It is worth mentioning that the back up surveillance unit 20 can be conveniently powered by the back-up light of the vehicle so that whenever the vehicle backs up, the back up surveillance unit 20 is automatically activated to capture the image from the rear side of the vehicle.

As shown in FIG. 1 to FIG. 2 of the drawings, the wireless GPS camera system further comprises a rechargeable battery 70 provided in the utility housing 60 to electrically connect with the display unit 30 and the control unit 40 so as to provide an adequate level of power to them. As a result, the user is able to conveniently install the wireless GPS camera system to virtually all kinds of vehicles without needing to resolve the problem of complicated electricity connection between the wireless GPS camera system and the vehicle. Since all vehicles should have a back-up light, electricity supply to the surveillance camera 21 and the wireless signal transmitter 24 can be easily acquired.

The control unit 40 comprises a control circuitry 41 electrically connected with the display unit 30 and the GPS unit 10 for optimally switching the operation of the present invention between the GPS mode and the back up monitoring mode, in such a manner that when the vehicle is moving forwardly or stopping, the GPS unit 10 is selectively activated to provide the positioning information on the display screen 31, and when the vehicle is moving backwardly (i.e. backing up), the back up surveillance unit 20 is automatically powered by the back-up light of the vehicle and the image captured by the surveillance camera 21 is wirelessly transmitted to the wireless signal receiver 23. The control unit 40 is activated and then automatically switches the display unit 30 to display the video information on the touch-screen 31. The driver is then able to observe the image at the rear side of the vehicle.

The detachable docking 50 comprises a docking base 51 supporting the utility housing 60 thereon and a docking support 52 upwardly extended from the docking base 51 for the rear side of the utility housing 60 lying thereat. Accordingly, the wireless signal receiver 23 is received at the docking base 51, wherein a communicating window is provided at a rear side of the docking base 51 that the wireless signal receiver 23 is aligned with the communicating window to wirelessly communicate with the wireless signal transmitter 24 at the surveillance camera 21. In other words, the communicating window is facing towards the wireless signal transmitter 24 and is set at the same direction of the touch-screen 31 of the display unit 30.

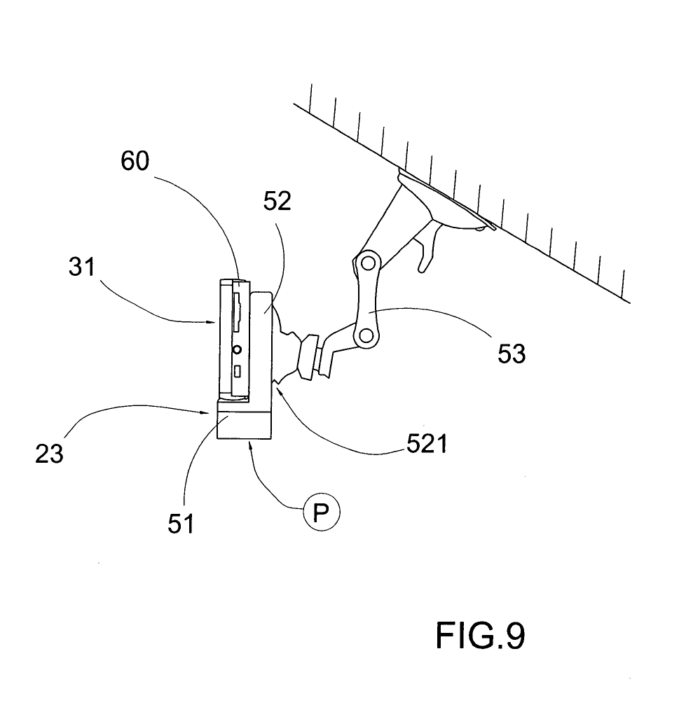

The docking support 52 comprises a terminal provided at a rear side thereof for electrically coupling with a socket of the utility housing 60 to operatively communicate with the display unit 30 when the utility housing 60 is detachably mounted at the detachable docking 50. In addition, a mounting slot 521 is provided at a front side of the docking support 52 to detachably couple with a mounting arm 53, wherein the mounting arm 53 is adapted to mount at the interior of the vehicle, such as a windshield, as shown in FIG. 9.

A charging circuit is received in the docking base 51, wherein a power extension is coupled between the docking base 51 and the power outlet of the vehicle to electrically connect the charging circuit with the power outlet of the vehicle. Therefore, when the utility housing 60 is detachably mounted at the detachable docking 50 to operatively connect the terminal with the socket, the rechargeable battery 70 will be automatically charged.

Preferably, the control unit 40 is received in the detachable docking 50 such that when the utility housing 60 is detachably mounted at the detachable docking 50 to operatively connect the terminal with the socket, the control unit 40 will switch the operation between the GPS mode and the back up monitoring mode. In other words, when the utility housing 60 is detached from the detachable housing 50, only the GPS mode can be activated. When the utility housing 60 is mounted at the detachable housing 50 at the same time the reverse gear is shifted by the driver, the back up monitoring mode is automatically activated for displaying the image at the rear side of the vehicle. In other words, once the wireless signal transmitter 24 is activated to wirelessly send out the signal to the wireless signal receiver 23, the control unit 40 will automatically activate at the back up monitoring mode. Once the driver shifts to the normal forward driving gear, the wireless signal transmitter 24 is then deactivated. Therefore, the control unit 40 will automatically activate at the GPS mode.

It is worth mentioning that the GPS processing module 11 can be pre-programmed to provide a number of functions. For example, the GPS processing module 11 can be loaded with a language pack which supports different languages (such as English, Spanish, Chinese, French, etc.) for guiding different drivers. The corresponding audible sound can be delivered through the speaker unit 12. Moreover, the GPS processing module 11 can also be loaded with specific operating programs supporting two or three dimensional maps, MP3s, photos, or tourist information. In other words, the present invention is a comprehensive driver's guide when he or she is driving.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A wireless GPS camera system for a vehicle, comprising:
a GPS unit arranged for providing a real-time positioning information of said vehicle;
a back up surveillance unit adapted for detachably mounting on a rear side of said vehicle to provide video information at said rear side of said vehicle;
a display unit electrically connected with said GPS unit and said back up surveillance unit for selectively displaying said positioning information and said video information; and
a control unit electrically connected said the GPS unit and said back up surveillance unit for being operated between a GPS mode and a back up monitoring mode, wherein in said GPS mode, said GPS unit is activated to allow said positioning information to be displayed on said display unit, wherein in said back up monitoring mode, said back up surveillance unit is activated to allow said video information to be displayed on said display unit.

2. The wireless GPS camera system, as recited in claim 1, wherein said back up surveillance unit comprises a surveillance camera which is adapted for detachably mounting on said rear side of said vehicle and is wirelessly connected to said control unit for wirelessly transmitting said video information to said display unit.

3. The wireless GPS camera system, as recited in claim 2, wherein said back up surveillance unit comprises a wireless signal transmitter linked to said surveillance camera and a wireless signal receiver which is linked to said control unit and is wirelessly communicated with said wireless signal transmitter for transmitting said video information from said surveillance camera to said control unit.

4. The wireless GPS camera system, as recited in claim 1, further comprising a utility housing adapted for detachably mounting into said vehicle, wherein said display unit and said display unit are received in said utility housing to form a portable GPS device.

5. The wireless GPS camera system, as recited in claim 2, further comprising a utility housing adapted for detachably supporting in said vehicle, wherein said display unit and said display unit are received in said utility housing to form a portable GPS device.

6. The wireless GPS camera system, as recited in claim 3, further comprising a utility housing adapted for detachably supporting in said vehicle, wherein said display unit and said display unit are received in said utility housing to form a portable GPS device.

7. The wireless GPS camera system, as recited in claim 4, further comprising a detachable docking adapted for detachably mounting into said vehicle, wherein said utility housing is detachably supported by said detachable docking.

8. The wireless GPS camera system, as recited in claim 5, further comprising a detachable docking adapted for detachably mounting into said vehicle, wherein said utility housing is detachably supported by said detachable docking.

9. The wireless GPS camera system, as recited in claim 6, further comprising a detachable docking adapted for detachably mounting into said vehicle, wherein said utility housing is detachably supported by said detachable docking.

10. The wireless GPS camera system, as recited in claim 6, further comprising a rechargeable battery provided in said utility housing to electrically connect with said display unit and said control unit so as to form said portable GPS device.

11. The wireless GPS camera system, as recited in claim 9, further comprising a rechargeable battery provided in said utility housing to electrically connect with said display unit and said control unit so as to form said portable GPS device.

12. The wireless GPS camera system, as recited in claim 9, wherein said wireless signal receiver is received at said detachable docking.

13. The wireless GPS camera system, as recited in claim 11, wherein said wireless signal receiver is received at said detachable docking.

14. The wireless GPS camera system, as recited in claim 9, wherein said detachable docking comprises a docking base, having a communicating window, supporting said utility housing thereon at a position that a touch screen of said display unit is set at the same direction of communicating window, and a docking support upwardly extended from said docking base for a rear side of said utility housing lying thereat, wherein said wireless signal receiver is received at said docking base to align with said communicating window for facing towards said wireless signal transmitter.

15. The wireless GPS camera system, as recited in claim 11, wherein said detachable docking comprises a docking base, having a communicating window, supporting said utility housing thereon at a position that a touch screen of said display unit is set at the same direction of communicating window, and a docking support upwardly extended from said docking base for a rear side of said utility housing lying thereat, wherein said wireless signal receiver is received at said docking base to align with said communicating window for facing towards said wireless signal transmitter.

16. The wireless GPS camera system, as recited in claim 13, wherein said detachable docking comprises a docking base, having a communicating window, supporting said utility housing thereon at a position that a touch screen of said display unit is set at the same direction of communicating window, and a docking support upwardly extended from said docking base for a rear side of said utility housing lying thereat, wherein said wireless signal receiver is received at said docking base to align with said communicating window for facing towards said wireless signal transmitter.

17. The wireless GPS camera system, as recited in claim 1, wherein said back up surveillance unit is arranged for electrically connecting to a back-up light of said vehicle, wherein said control unit is automatically switched to said back up monitoring mode for displaying said video information on said display unit when an activation of said back-up light of said vehicle.

18. The wireless GPS camera system, as recited in claim 16, wherein said back up surveillance unit is arranged for electrically connecting to a back-up light of said vehicle, wherein said control unit is automatically switched to said back up monitoring mode for displaying said video information on said display unit when an activation of said back-up light of said vehicle.

19. The wireless GPS camera system, as recited in claim 6, wherein said back up surveillance system further comprises a detachable camera mount adapted for detachably mounting onto a rear license plate of said vehicle to wirelessly communicate with said control unit, wherein said detachable camera mount comprises a camera housing receiving said surveillance camera therein and two supporting arms transversely extended from two sides of said camera housing respectively, wherein each of said supporting arms has a connecting hole arranged in such a manner that said two connecting holes of said supporting arms are aligned with two connecting pins of said license plate of said vehicle to mount said detachable camera mount at said rear license plate of said vehicle.

20. The wireless GPS camera system, as recited in claim 18, wherein said back up surveillance system further comprises a detachable camera mount adapted for detachably mounting onto a rear license plate of said vehicle to wirelessly communicate with said control unit, wherein said detachable camera mount comprises a camera housing receiving said surveillance camera therein and two supporting arms transversely extended from two sides of said camera housing respectively, wherein each of said supporting arms has a connecting hole arranged in such a manner that said two connecting holes of said supporting arms are aligned with two connecting pins of said license plate of said vehicle to mount said detachable camera mount at said rear license plate of said vehicle.
